(19) United States
(12) Patent Application Publication
(10) Pub. No.: US 2018/0232792 A1
(43) Pub. Date: Aug. 16, 2018

(54) INTEGRATED FASHION AND ATHLETICS APPLICATION AND METHODS AND USES THEREOF

(71) Applicant: ZUTING INCORPORATED, Silver Spring, MD (US)

(72) Inventors: Mounda WILLIAMS, Silver Spring, MD (US); MacKenzie SHERMAN, Silver Spring, MD (US)

(73) Assignee: ZUTING INCORPORATED, Silver Spring, MD (US)

(21) Appl. No.: 15/751,736

(22) PCT Filed: Aug. 8, 2016
(86) PCT No.: PCT/US2016/045965

§ 371 Date: Feb. 9, 2018

Related U.S. Application Data
(60) Provisional application No. 62/203,430, filed on Aug. 11, 2015.

(51) Int. Cl. G06Q 30/06; G06Q 20/20; G06F 17/30

(52) U.S. Cl. CPC G06Q 30/0623; G06Q 20/20; H04W 88/02; G06F 17/3002; G06F 17/30867

(57) ABSTRACT

Systems and methods for integrating athletics and fashion, including aggregating, cataloging, categorizing, and/or disseminating fashion trends and styles of athletes, sport teams/clubs, and/or other celebrities. The systems and methods can include the aggregation, cataloging, categorization, and/or dissemination of fashion-related information, media, and other information associated with athletes and sport teams/clubs, and user provided information.

### CROSS REFERENCE TO RELATED APPLICATIONS

This patent application claims priority to U.S. Provisional Patent Application No. 62/203,430, filed Aug. 11, 2015, which is incorporated herein by reference in its entirety.

### BACKGROUND

### Field

Embodiments described herein generally relate to mobile applications, including applications integrating fashion and athletics.

### Related Art

Professional sports organizations, such as the National Basketball Association (“NBA®”), have implemented dress codes for its players, requiring them to shed their casual athletic wear and to instead don more sophisticated apparel for pre-game and post-game appearances. These dress codes have since been widely embraced by the world's most recognizable athletes, and are now a tradition in which the athletes take considerable pride. Today, the athletes confidently step into the public eye, making their pre-game or post-game appearances dressed in the trendiest of ensembles, and providing an opportunity for designer brands' to share the spotlight with their favorite athletes. As a result, professional sports organizations and athletes have revolutionized the luxury clothing, footwear and accessories brand market by transforming a team's or athlete's fan base into a potential customer base for such goods.

With the proliferation of mobile devices and the popularity of mobile applications and social media, there is a need to capture the excitement, whether in real-time or otherwise, surrounding the fusion of luxury clothing, footwear and accessories brand market and athletes or teams (whether professional or otherwise) utilizing such mobile devices. There is also a need for a single platform that allows sports fans/consumers to view, review, post, critique, research and buy goods worn by or are associated with various teams or athletes. However, present technology does not address these technological needs.

### BRIEF SUMMARY

In consideration of the above problems, in accordance with one aspect disclosed herein, an electronic device comprising communication circuitry configured to communicate with a web service; and control circuity configured to receive fashion information associated with one or more athletes from the web service using the communication circuitry, the fashion information including multimedia information and categorical information; categorize the multimedia information based on categorical information; and associate at least one portion of the categorized multimedia information with one or more users of the electronic device.

In an exemplary embodiment, the control circuitry is further configured to receive commentary of the at least one portion of the categorized multimedia information; and associate the commentary with the at least one portion of the categorized multimedia information.

In an exemplary embodiment, the multimedia information comprises a video corresponding to the one or more athletes.

In an exemplary embodiment, the fashion information comprises one or more of designer information, brand information, and style information.

In an exemplary embodiment, associating of the at least one portion of the categorized multimedia information comprising selecting the at least one portion of the categorized multimedia information as favorite multimedia information.

In an exemplary embodiment, the control circuitry is further configured to associate the one or more athletes with the one or more users of the electronic device to receive additional fashion information associated with the one or more athletes.

In an exemplary embodiment, the control circuitry is further configured to add commentary to the multimedia information and to provide the commentary to the web service.

In an exemplary embodiment, the categorical information includes information associated with one or more of athletes, sports leagues and sports teams.

In an exemplary embodiment, the control circuitry is further configured to determine a point-of-sale location based on the fashion information; and purchase a fashion item identified in the fashion information from the determined point-of-sale location.

In an another aspect, a server comprising communication circuitry configured to communicate with an electronic device; and control circuity configured to manage fashion information associated with one or more athletes and provide the fashion information to the electronic device using the communication circuitry, the fashion information including multimedia information and categorical information; categorize the multimedia information based on categorical information; and associate information received from one or more users of the electronic device with the categorized multimedia information.

In an exemplary embodiment, the control circuitry is further configured to receive commentary of at least one portion of the categorized multimedia information; and associate the commentary with the at least one portion of the categorized multimedia information.

In an exemplary embodiment, the multimedia information comprises a video corresponding to the one or more athletes.

In an exemplary embodiment, the fashion information comprises one or more of designer information, brand information, and style information.

In an exemplary embodiment, the associating information received from one or more users comprises associating user-provided commentary to the categorized multimedia information.

In an exemplary embodiment, the associating information received from one or more users comprises identifying at least a portion of the categorized multimedia information as favorite information of the one or more users.

In an exemplary embodiment, the control circuitry is further configured to provide additional fashion information to the one or more users based on the associated information received from one or more users.

In an exemplary embodiment, the categorical information comprises information associated with one or more of athletes, sports leagues and sports teams; and information associated with one or more of designer information, brand information, and style information.

In an exemplary embodiment, the control circuitry is further configured to determine a point-of-sale location based on the fashion information; provide the determined point-of-sale location to the one or more users of the electronic device; and purchase a fashion item identified in the fashion information from the determined point-of-sale location based on a purchase request received from the one or more users of the electronic device.

In another aspect, a method for integrating fashion and athletics using an electronic device, the method comprising receiving fashion information associated with one or more athletes from a web service, the fashion information including multimedia information and categorical information; categorizing the multimedia information based on categorical information; associating at least one portion of the categorized multimedia information with one or more users of the electronic device; and receiving additional fashion information from the web service based on the associating the at least one portion of the categorized multimedia information.

In an exemplary embodiment, the method further comprising determining a point-of-sale location based on the fashion information; and purchasing a fashion item identified in the fashion information from the determined point-of-sale location.

In another aspect, a computer program product embodied on a computer-readable medium comprising program instructions, when executed, causes a processor to perform any of the methods set forth in this application.

In another aspect, an apparatus comprising means to perform any of the methods set forth in this application.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments. The drawings are for illustration purposes only and are not necessarily drawn to scale. The present disclosure itself, however, may best be understood by reference to the detailed description which follows when taken in conjunction with the accompanying drawings in which:

FIG. 1 illustrates an electronic device according to exemplary embodiments of the present disclosure.

FIG. 2 illustrates a system architecture according to exemplary embodiments of the present disclosure.

FIG. 3 illustrates a flowchart of an application process according to an exemplary embodiment of the present disclosure.

FIG. 4A illustrates a splash screen according to an exemplary embodiment of the present disclosure.

FIG. 4B illustrates a login screen according to an exemplary embodiment of the present disclosure.

FIG. 4C illustrates a registration screen according to an exemplary embodiment of the present disclosure.

FIG. 5A illustrates a home screen according to an exemplary embodiment of the present disclosure.

FIG. 5B illustrates a roster screen according to an exemplary embodiment of the present disclosure.

FIG. 5C illustrates a player content screen according to an exemplary embodiment of the present disclosure.

FIG. 5D illustrates a video player according to an exemplary embodiment of the present disclosure.

FIG. 5E illustrates a style picture according to an exemplary embodiment of the present disclosure.

FIG. 5F illustrates a home screen according to an exemplary embodiment of the present disclosure.

FIG. 6 illustrates a video player according to an exemplary embodiment of the present disclosure.

FIG. 7 illustrates a team page according to an exemplary embodiment of the present disclosure.

FIG. 8 illustrates a favorite's page according to an exemplary embodiment of the present disclosure.

FIG. 9A illustrates a favorite's page according to an exemplary embodiment of the present disclosure.

FIG. 9B illustrates a comments section according to an exemplary embodiment of the present disclosure.

FIG. 10 illustrates a brand page according to an exemplary embodiment of the present disclosure.

FIG. 11 illustrates a player content page according to an exemplary embodiment of the present disclosure.

FIG. 12A illustrates a settings page according to an exemplary embodiment of the present disclosure.

FIG. 12B illustrates a profile page according to an exemplary embodiment of the present disclosure.

FIG. 12C illustrates a preference page according to an exemplary embodiment of the present disclosure.

FIG. 13 illustrates a computer system according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

By way of overview, exemplary embodiments of the present disclosure include systems and methods for integrating athletics and fashion, including aggregating, cataloging, categorizing, and/or disseminating fashion trends and styles of athletes, sport teams/clubs, and/or other celebrities. The systems and methods can include (but are not limited to), the aggregation, cataloging, categorization, and/or dissemination of fashion-related information, media (e.g., videos, images, etc.), and other information associated with athletes and sport teams/clubs, user provided information (e.g., user comments, user submitted media (images, videos, etc.), and/or other user provided information regarding one or more athletes/teams. In one or more exemplary embodiments, the systems and methods can link one or more users to one or more virtual and/or brick-and-mortar commercial shopping centers/stores and/or provide the user(s) the option to, and facilitate the purchase of one or more fashion and/or sport related items (e.g., clothing, accessories, etc.). For example, the system can be configured to provide the user with media and other content associated with an athlete, including particular fashion items worn by the athlete. The media and other content can include links to one or more stores in which the fashion and/or athletic item can be purchased and/or provide the user with the option to purchase the item directly or via the linked store. In this example, the item can be purchased directly via the system (e.g., via the mobile application) for shipment to the user and/or the item can be purchased/reserved for pickup at a brick-and-mortar store.

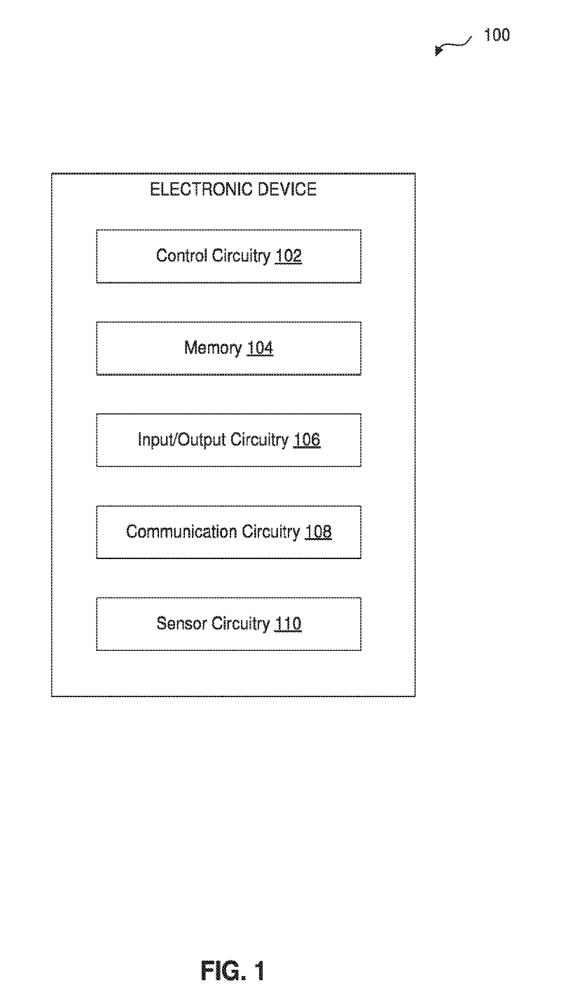

FIG. 1 illustrates a schematic view of an illustrative electronic device 100 according to an exemplary embodiment of the present disclosure. The electronic device 100 can be configured to interface with one or more media hosting services, server and/or website systems, and/or virtual and/or brick-and-mortar commercial shopping centers/stores according to one or more exemplary embodiments of the present disclosure.

Electronic device 100 can include control circuitry 102, memory 104, input/output (“I/O”) circuitry 106, communications circuitry 108 and/or sensor circuitry 110. In some embodiments, one or more of the components of electronic device 100 can be combined or omitted. Further, in some embodiments, electronic device 100 can include other components not combined or included in FIG. 1, including, for example, a power supply (e.g., a battery or kinetics), a display, bus, etc., and/or can include several instances of one or more of the components illustrated in FIG. 1.

Electronic device 100 can include any suitable type of electronic device, including (but are not limited to) a mobile computing device—such as a laptop computer, a tablet computer, a mobile telephone or smartphone, a “phablet,” a personal digital assistant (PDA), and media player, personal e-mail device, digital camera, handheld gaming device, and a wearable computing device—such as a computerized wrist watch or “smart” watch, and computerized eyeglasses. In some embodiments of the present disclosure, the electronic device 100 may be a larger (e.g., stationary) computing device, such as a personal computer (PC), a desktop computer, a computerized kiosk, and/or an automotive/aeronautical/maritime in-dash computer terminal.

Control circuitry 102 can include processor circuitry configured to control the overall operation of the electronic device 100, including running one or more operating systems (OS), OS applications, firmware applications, media playback applications, media editing applications, or any other application. In some embodiments, control circuitry 102 can drive a display and process inputs received from a user interface of electronic device 100. In an exemplary embodiment, the OS can be Google Android, Apple iOS, Microsoft Windows, Linux, Unix, or one or more other operating systems as would be understood by one of ordinary skill in the relevant arts.

Memory 104 can include one or more storage mediums, such as any well-known volatile and/or non-volatile memory. The storage medium(s) can include, for example, read-only memory (ROM), random access memory (RAM), flash memory, a magnetic storage media, an optical disc, erasable programmable read only memory (EPROM), and programmable read only memory (PROM). The memory 104 can be non-removable, removable, or a combination of both.

The memory 104 can store, for example, data and/or instructions, where when the instructions are executed by the control circuitry 102, controls the control circuitry 102 to perform the functions described herein. The memory 104 can also store, for example, media data—such as text, music, images, and/or video files; application data—such as data for implementing functions on electronic device 100; firmware; user profile information data—such as, username, contact information (e. g, email address, phone number, mailing address, etc.), age, country, occupation, education, gender, profile picture(s), and/or cover/background profile picture(s); connected user information data—such as friends, associates, other connected users, etc.); favorite and/or subscription information data—such as favorite sports, teams, athletes, coaches, etc., favorite fashion designers, fashion lines, styles, etc.; commercial store information data—such as available virtual and/or brick-and-mortar stores (e.g., clothing, athletic, and/or other fashion-related store locations); authentication information—such as passwords, keys, libraries of data associated with authorized users, etc.; preference information data—such as application preferences, media playback preferences, and/or other user settings/preferences; lifestyle information data; transaction and/or payment information data—such as credit card information, banking information, etc.; wireless connection information data—such as wireless network authentication information and/or other information that can enable electronic device 100 to establish a wireless connection; calendar information data, and/or any other suitable data or any combination thereof.

Input/output (“I/O”) circuitry 106 can include processor circuitry configured to interface within one or more users and/or external components—such as a multi-touch sensor of a display, mouse, keyboard, camera, microphone, speaker, data port/connector (e.g., Universal Serial Bus (USB) connector, 30-pin connector, lightning connector, display port, etc.), etc. The I/O circuitry 106 can be configured to process one or more input and/or output signals, including converting and/or encoding/decoding signals (e.g., analog-to-digital and/or digital-to-analog conversions). In an exemplary embodiment, the I/O circuitry 106 can receive and convert physical contact inputs (e.g., from a multi-touch screen), physical movements (e.g., from a mouse or sensor), audio signals (e.g., from a microphone), images and/or video (e.g., from a camera), biometric information (e.g., fingerprints, retina information) received from one biometric sensors, position or movement information (e.g., from a GPS, accelerometer, etc.), or any other input.

The input and/or output signals can be provided to and received from control circuitry 102, memory 104, communication circuitry 108, sensor circuitry 110, or any other component of electronic device 100.

Electronic device 100 can include any suitable interface or component configured to allow an external component and/or a user to provide inputs to I/O circuitry 106, and/or for providing outputs to one or more external components and/or users. For example, electronic device 100 can include any suitable input mechanism—such as a keypad/keyboard, button, dial, click wheel, touch screen, microphone, camera, environmental, position, and/or biometric sensor(s), etc. The electronic device 100 can include any suitable output mechanism—such as speaker, display, notification light, headphone jack, data port/connector (e.g., USB connector, 30-pin connector, lightning connector, display port, etc.), vibration or haptic-feedback device, etc.

In an exemplary embodiment, I/O circuitry 106 can include display circuitry (e.g., a screen or projection system) for providing a display visible to the user. For example, the display circuitry can include a screen (e.g., a LED, OLED, or LCD screen) that is incorporated in the electronic device 100. The display circuitry can include a movable display or a projecting system for providing a display of content (e.g., a video projector). The display circuitry can include a coder/decoder (CODEC) to convert digital media data into analog signals. For example, the display circuitry (or other appropriate circuitry within electronic device 100) can include video CODECS, audio CODECS, or any other suitable type of CODEC.

The display circuitry also can include display driver circuitry, circuitry for driving display drivers, or both. The display circuitry can be configured to display content—such as media (e.g., text, images, video, etc.), application screens for applications implemented on the electronic device 100, information regarding ongoing communications operations, information regarding incoming communications requests, or device operation screens) under the direction of control circuitry 102. Alternatively, the display circuitry can be configured to provide instructions to a remote display.

Communications circuitry 108 can processor circuitry configured for transmitting and/or receiving communications conforming to one or more wireless and/or wired protocols. In exemplary embodiments, the communications circuitry 108 can include (but is not limited to) a transmitter, a receiver, a transceiver, a digital signal processer (DSP), modulator and/or demodulator, a digital-to-analog converter (DAC) and/or an analog-to-digital converter (ADC), and/or a frequency converter (including mixers, local oscillators, and filters) that can be utilized in transmitting and/or receiving of wireless and/or wired communications.

Communications circuitry 108 can be configured to interface with one or more communication networks and/or other electronic devices using any suitable communications protocol, including (but is not limited to), for example, one or more cellular communication protocols—such as Long-Term Evolution (LTE), Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), and/or Worldwide Interoperability for Microwave Access (WiMAX) (IEEE 802.16); and/or one or more other wireless and/or wired communication protocols—such as, Wi-Fi (IEEE 802.11), Bluetooth, Near-field Communication (NFC) (ISO/IEC 18092), ZigBee (IEEE 802.15.4), Z-wave, radio frequency (RF) systems (e.g., 900 MHz, 1.4 GHz, and 5.6 GHz communication systems), voice over internet protocol (“VOIP”) and/or Radio-frequency identification (RFID), Ethernet, and/or infrared, to provide some examples.

As will be understood by those skilled in the relevant arts, the electronic device 100 can include one more instances of communications circuitry 108 for simultaneously performing several communications operations using different communications networks, although only one is shown in FIG. 1. For example, electronic device 100 can include a first instance of communications circuitry 108 for communicating over a cellular network, and a second instance of communications circuitry 108 for communicating over Wi-Fi or Bluetooth. In an exemplary embodiment, the same instance of communications circuitry 108 can be configured to exchange communications conforming to two or more communication protocols.

The sensor circuitry 110 can include processor circuitry configured to determine the position and/or movement of the electronic device 100. For example, the sensor circuitry 110 can include one or more positional and/or movement sensors (e.g., GPS, accelerometer, gyroscope sensor, etc.). The location and/or movement of the electronic device 100 can also be determined using one or more positional determinations using signal characteristics relative to one or more base stations and/or access points (via the communication circuitry 108). In an exemplary embodiment, the sensor circuitry 110 can be configured for navigational purposes utilizing one or more well-known navigational systems, including the Global Navigation Satellite System (GNSS), the Russian Global Navigation Satellite System (GLONASS), the European Union Galileo positioning system (GALILEO), the Japanese Quasi-Zenith Satellite System (QZSS), the Chinese BeiDou navigation system, and/or the Indian Regional Navigational Satellite System (IRNSS) to provide some examples.

In an exemplary embodiment, the electronic device 100 can include one or more software applications configured to aggregate, catalog, categorize, and/or disseminate fashion-related trends and styles, including fashion-related information of one or more athletes, sport teams/clubs, and/or other celebrities. For example, the application can obtain and process fashion-related information, media (e.g., text, videos, images, etc.), and other information associated with athletes and sport teams/clubs, user provided information (e.g., user comments, user submitted media (images, videos, etc.), and/or other user provided information regarding one or more athletes/teams. In one or more exemplary embodiments, the application can link one or more users to one or more virtual and/or brick-and-mortar commercial shopping centers/stores and/or provide the user(s) the option to, and facilitate the purchase of one or more fashion and/or sport related items (e.g., clothing, accessories, etc.). For example, the application can be configured to provide the user with media and other content associated with an athlete, including particular fashion items worn by the athlete. The media and other content can include links to one or more stores in which the fashion/athletic item can be purchased and/or provide the user with the option to purchase the item directly or via the linked store. In this example, the item can be purchased directly via the system (e.g., via the mobile application) for shipment to the user and/or the item can be purchased/reserved for pickup at a brick-and-mortar store.

In an exemplary embodiment, the application can interface with one or more media hosting services, and/or server and/or website systems to access fashions related information of one or more athletes, sport teams/clubs, and/or other celebrities. In operation, the application can be configured to connect to one or hosting services, servers, and/or website systems to exchange (provide and/or receive) data (e.g., fashion-related information) with the hosting services, servers, and/or website systems. The application can process the fashion-related information and/or instruct/control the media hosting services, servers, and/or website systems to process the information. For example, the application can access and/or processes (or instruct the host/server to process) the fashion-related information, media (e.g., videos, images, etc.), and other information associated with athletes and sport teams/clubs, user provided information (e.g., user comments, user submitted media (images, videos, etc.), and/or other user provided information regarding one or more athletes/teams.

In an exemplary embodiment, the application can interface with one or more virtual and/or brick-and-mortar commercial shopping centers/stores to facilitate the purchase of one or more fashion and/or sport related items (e.g., clothing, accessories, etc.). For example, the application can be configured to provide the user with media and other content associated with an athlete, including particular fashion items worn by the athlete. The media and other content can include links to one or more stores in which the fashion/athletic item can be purchased and/or provide the user with the option to purchase the item directly or via the linked store. In this example, the item can be purchased directly via the system (e.g., via the mobile application) for shipment to the user and/or purchased/reserved the item for pickup at a brick-and-mortar store.

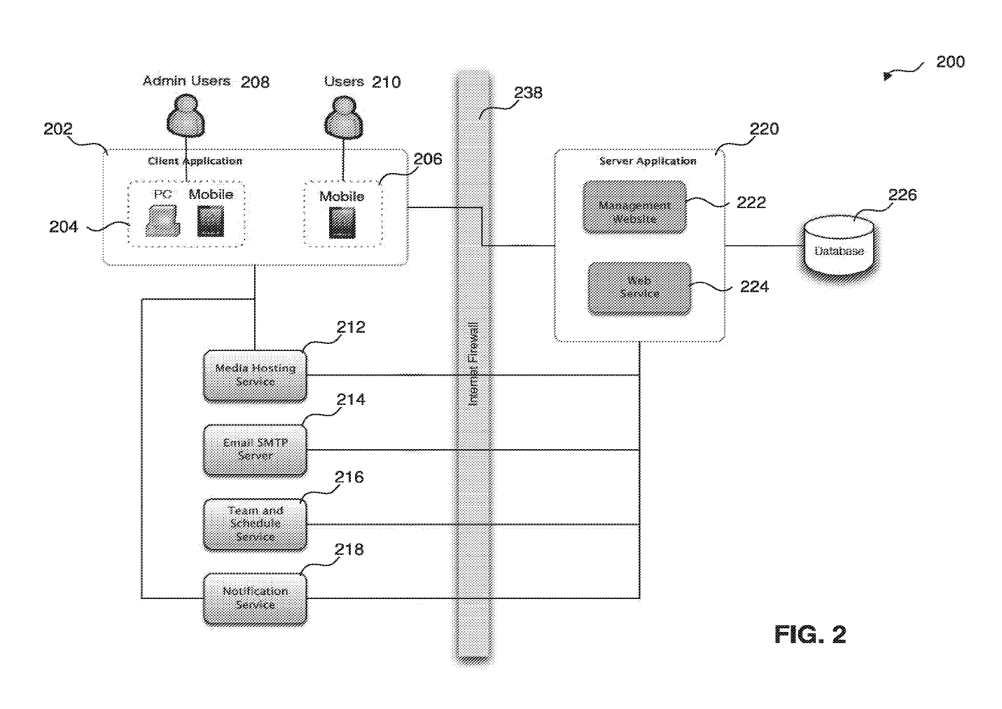

In this manner, an electronic device (e.g., electronic device 100 of FIG. 1), can allow a user to perform various operations to provide fashion-related information of one or more athletes, sport teams/clubs, other celebrities, and/or one or more other users to the user of the application, to collect information from the user and/or one or more external sources—such as news organizations, fashion designers, fashion and/or sports blogs, sport organizations (e.g., teams, clubs, leagues, etc.), athletes, and/or one or more other sources as would be understood by one of ordinary skill in the relevant arts. In some embodiments, these various operations/functions can be provided through a single, integrated application of the electronic device (e.g., application 202 in FIG. 2).

For example, a single, integrated application could be used by the user to view/research fashion-related information (e.g., trends and/or styles) associated with one or more fashion entities (e.g., designers, labels, companies, etc.), as well as view/research one or more athletes and/or other users wearing and/or promoting the clothing and/or accessories of these corresponding fashion entities. As discussed previously, the integrated application can also facilitate the purchase of such clothing and/or accessories.

Moreover, although specific examples are listed above, one skilled in the art could appreciate that a user can make use of a single, integrated application in any suitable situation in the context of fashion. Further, it will be understood by those skilled in the art that the application can be configured to integrate fashion (and/or one or more other industries and/or services) with athletics and/or one or more other demographics, in accordance with other embodiments of the present disclosure.

FIG. 2 illustrates system architecture 200 according to an exemplary embodiment of the present disclosure. The system architecture 200 illustrates the interfacing of one or more electronic devices (e.g., electronic device 100) running an exemplary integrated application 202 with a server application 220, media hosting service 212, email server 214, team and schedule service 216, and notification service 218. For example, integrated application 202 can operate on a mobile electronic device 206 by user 210. The integrated application 202 can also operate on an electronic device 204 by an administrator 208. In this example, the electronic device 204 can be a mobile device, such as a mobile phone or tablet, or can be larger electronic device, such as a laptop or desktop computer. As will be explained in more detail below, the administrator 208 is a user with elevated privileges when compared to user 210. The mobile device 206, electronic device 204, media hosting service 212, email server 214, team and schedule service 216, and notification service 218 are separated from the server application 220 by network/internet firewall 238.

The server application 220 can include management website 222 and web service 224, and be configured to access database 226 and communicate with one or more electronic devices (e.g., electronic device 100), media hosting service 212, email server 214, team and schedule service 216, and/or notification service 218 using communication circuitry. The communication circuitry of the server application 220 can be similar to the communication circuitry 102. The server application 220 can include processor circuitry configured to control the overall operation of the server application 220, including the communication circuitry and the management website 222 and web service 224. The database 226 can include memory that stores, for example, user profile details, user favorites, media information, media metadata, user comments, brand details, and/or brand comments. In an exemplary embodiment, the database 226 can include processor circuitry configured to process the stored information, including facilitating the exchange of the stored information with the server application 220. In an exemplary embodiment, the database 226 does not store image or video content associated with fashion-related information and/or one or more athletes, teams, etc. Rather, as explained in more detail below, the media hosting service 212 can be configured to store the image or video content. However, the database 226 is not limited to this configuration and can store image and video content in other embodiments.

The management website 222 can include processor circuitry configured to manage one or more websites associated with the integrated application 202. The management website 222 can manage the website(s) that are hosted by web service 224, including managing content (e.g., videos, images, player/team information, fashion brand information, sales information, etc.) of the website that is accessible to the user 210, content added to the website by the user 210 (e.g., comments, video, images, etc.). In an exemplary embodiment, the administrator 208 can upload content to the website via the management website 222.

The web service 224 can include processor circuitry configured to host one or more websites associated with the integrated application 202. The web service 224 can be configured to interface with the media hosting service 212, email server 214, team and schedule service 216, and notification service 218 via one or more wireless and/or wired connections. For example, the web service 224 can access videos and/or images hosted by media hosing service 212 to include one or more videos and images on the website. The web service 224 can access the email server 214 to send and/or receive emails. For example, web service 224 can send or receive emails to/from one or more users 210. The web service 224 can access the team and schedule service 216 to access information associated with one or more athletic teams, players, or organizations to include the information on the website(s). The web service 224 can interface with the notification service 218, and be configured to control the notification service 218 to generate and transmit notifications to the user(s) 210. For example, the notification service 218 can be configured to generate one or more notifications (e.g., email messages, text messages, push notifications and/or other alerts) in response to instructions from the web service 224, and to transmit the notification(s) to the user(s) 210.

The media hosting service 212 can include processor circuitry configured to host one or more videos, images, and/or other data, and interface with the web service 224 and one or users 210. In an exemplary embodiment, the media hosting service 212 can provide the user(s) 210, administrators 208, and/or the server application 220 (management website 222 and/or web service 224) with access to one or more videos, images, and/or other data hosted by the media hosting service 212. For example, the media hosting service 212 can host image and/or videos that are utilized in one or more websites hosted by the web service 224. The media hosting service 212 can also be configured to host images, videos, and/or other data associated with one or more users 210, including, for example, user images (e.g., profile pictures, user uploaded images and/or videos, etc.), images and/or videos that have been tagged or marked as a favorite by the user(s) 210 (e.g., favorited images/videos), etc. In an exemplary embodiment, the media hosting service 212 is a third-party media service.

The email server 214 can include processor circuitry configured to route email messages between the web service 224 and one or more users 210. The email server 214 can include one or more databases (e.g., memory) that store mail routing rules, user account information, and/or email messages. The email server 214 can also include one or more communication circuits configured to interface with the web service 224 and/or one or more users 210. In an exemplary embodiment, the email server 214 includes a Simple Mail Transfer Protocol (SMTP) mail server that is configured to process and transmit email messages.

The team and schedule service 216 can include processor circuitry configured to maintain and process information associated with one or more athletic teams, players, or organizations. The team and schedule service 216 includes one or more servers configured to host the information associated with one or more athletic teams, players, or organizations, including, player, team, and/or league statistics, league schedules, team events, and/or other team, player, and/or league data. Team and schedule service 216 can be connected to the server application 220, and can be configured to interface with the web service 224 to provide information included in one or more websites hosted by the web service 224.

The notification service 218 can include processor circuitry configured to manage notifications and provide the notifications to one or more users 210. In exemplary embodiment, the notification service 218 can be configured generate and transmit notifications to the user(s) 210 based on instructions from the web service 224. For example, the notification service 218 can be configured to generate one or more notifications (e.g., email messages, text messages, push notifications and/or other alerts) in response to instructions from the web service 224, and to transmit the notification(s) to the user(s) 210.

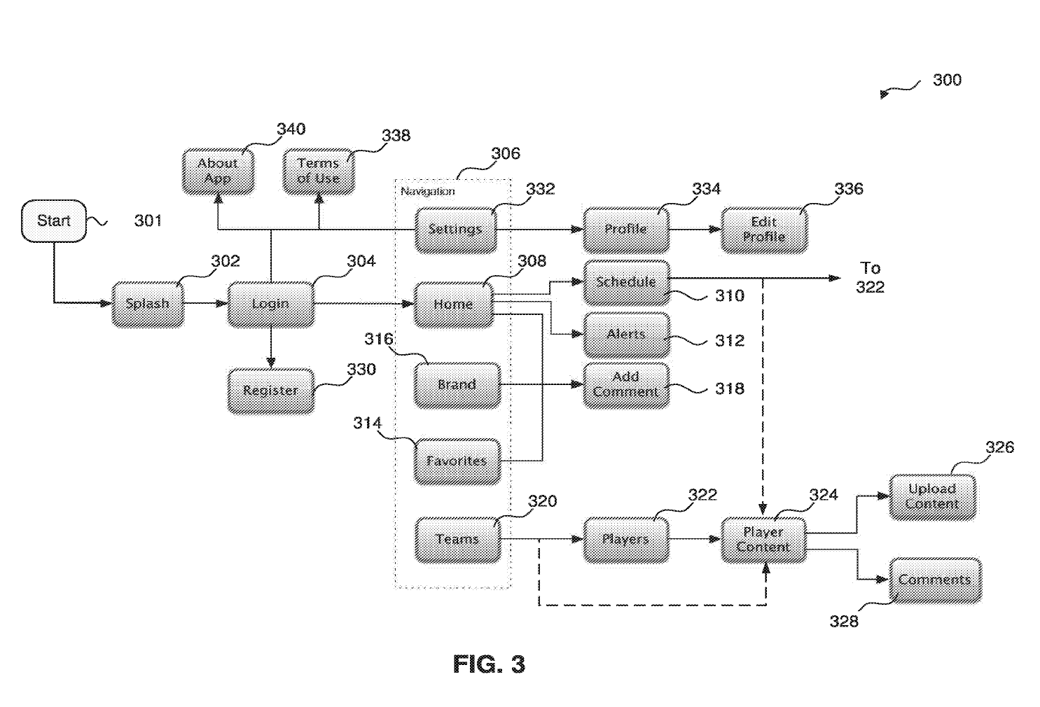

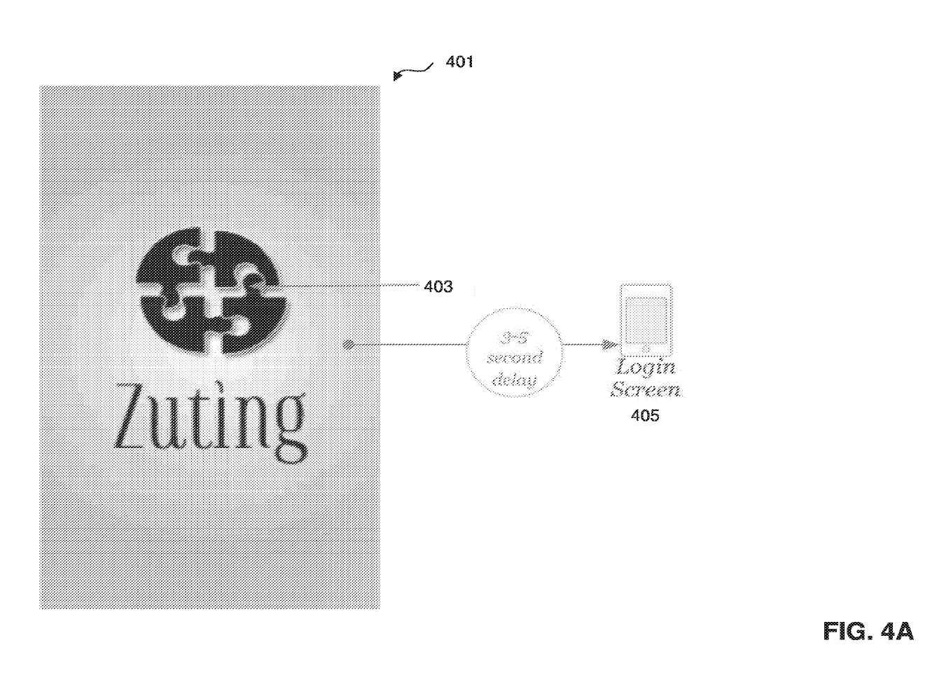

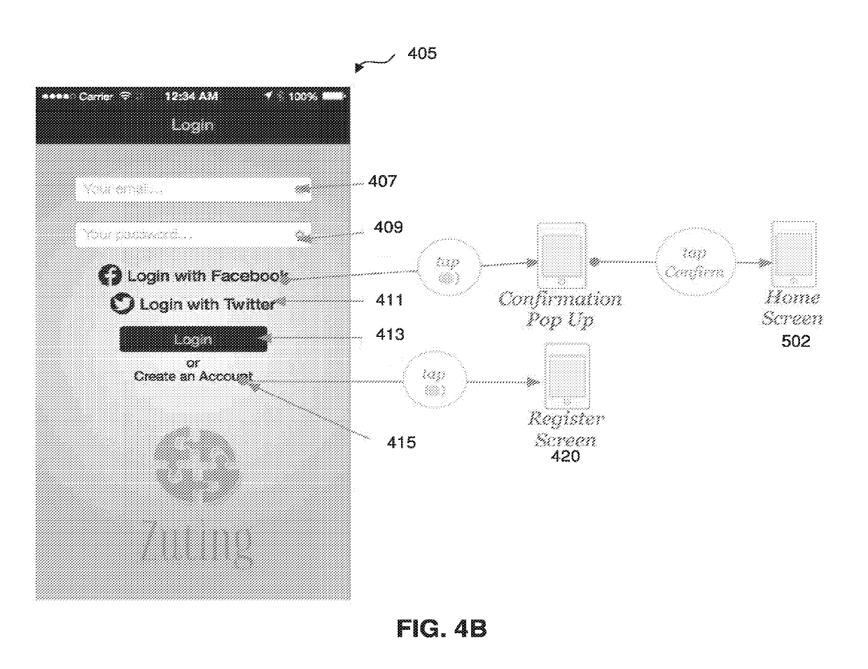

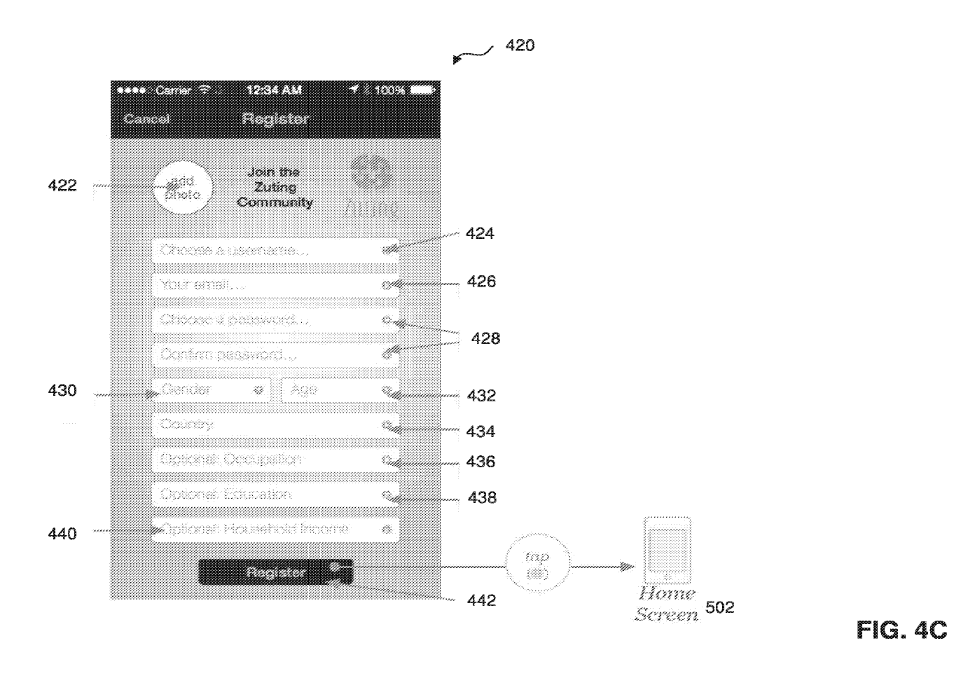

FIG. 3 illustrates a flowchart of an application process 300 according to an exemplary embodiment of the present disclosure. The flowchart of the application process 300 is described with reference to FIGS. 4A-12C and with continued reference to FIGS. 1 and/or 2. The steps of the flowcharts 300 are not limited to the order described below, and the various steps may be performed in a different order.

The flowchart 300 begins at step 301, where the application 202 is initialized. The initialization of the application 202 can be in response to the powering on of the electronic device in which the application 202 has been installed, or based on a user input. For example, the application 202 may be presented to the user as an icon or other symbol on a display of the electronic device that is activated by being selected by the user.

After step 301, the flowchart can transition to step 302, where a splash screen for the application 202 is displayed during and/or following the initiation of the application 202. FIG. 4A illustrates an example splash screen 401 according to an exemplary embodiment. The splash screen 401 can include a logo, name, and/or other information 403 of the application 202. For example, the splash screen 401 can be displayed for an amount of time (e.g., 3-5 seconds) during and/or following the initiation of the application 202. The amount of time displayed can be a predetermined amount of time, or the time necessary to initialize the application. As illustrated in FIG. 4B, the flowchart 300 can transition to the next step 304 after the splash screen 401 has been displayed

At step 304, the application 202 can display a login screen 405. The login screen 405 can include a username field 407 and a password field 409 configured to accept a username and password as the user's credentials. The username can be, for example, an email address associated with the user. After the credentials have been entered in the username field 407 and the password field 409, the user can select the login button 413 to initiate a login sequence. In an exemplary embodiment, the login sequence can include an exchange of communications with the web service 224 to verify the login credentials of the user following the selection of the login button 413. The user can also login to the application 202 using credentials 411 from another website or online service (e.g., Facebook, Twitter, etc.) instead of providing credentials in the username field 407 and the password field 409. If the user does not have an existing account associated with the application 202, the user can select the “create an account” button 415 to initiate an account creation process and proceed to the registration screen 420 (step 330) to create an account as illustrated in FIG. 4C.

At step 330, a registration screen 420 is displayed to the user. The registration screen 420 can include a username field 424 for entry of a desired username, an email field 426 for entry of the user's email, passwords fields 428 for entry and confirmation of a desired password, a gender field 430 for entry of the user's gender, an age field 432 for entry of the user's age, a country field 434 for entry of the user's country, an occupation field 436 for entry of the user's occupation, an education field 438 for entry of the user's education level, and a household income field 440 for entry of the user's income. The registration screen 420 in not limited to these exemplary fields and the registration screen 420 can include one or more additional fields and/or some of the fields 424-440 may be omitted. Further, one or more of the fields may be optional and not required to complete the registration.

The registration screen 420 can also include a photo field 422 that can include an image uploaded by the user. The image can be, for example, a profile picture that is to be associated with the user's account. In some embodiments, if a profile picture is not uploaded, the user's account can include a default image or graphic that functions as the user's profile picture.

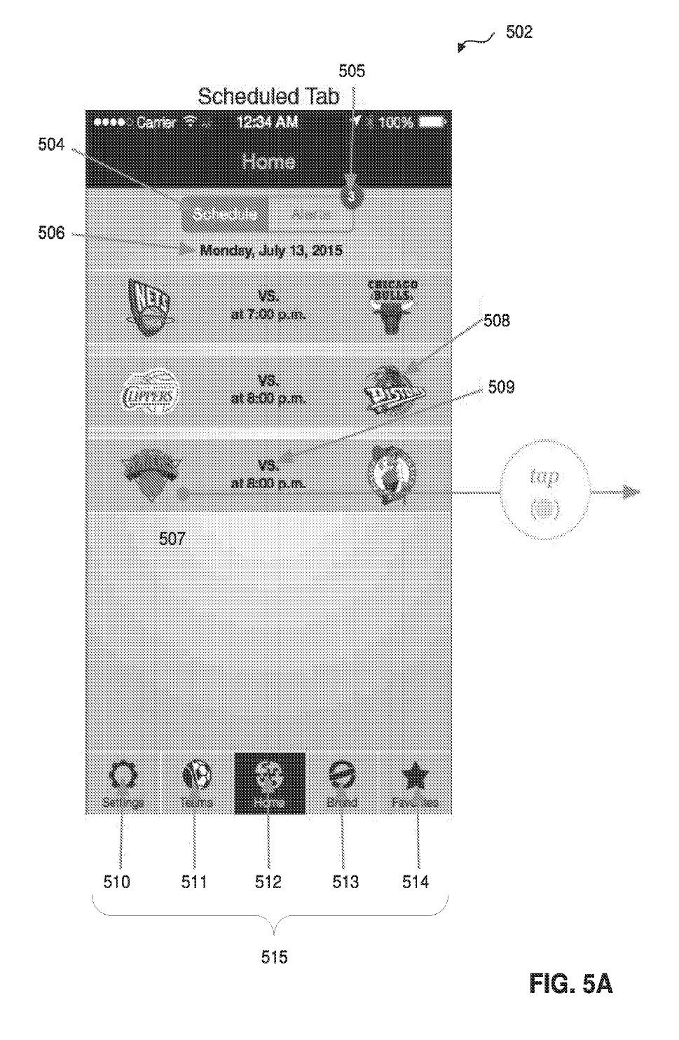

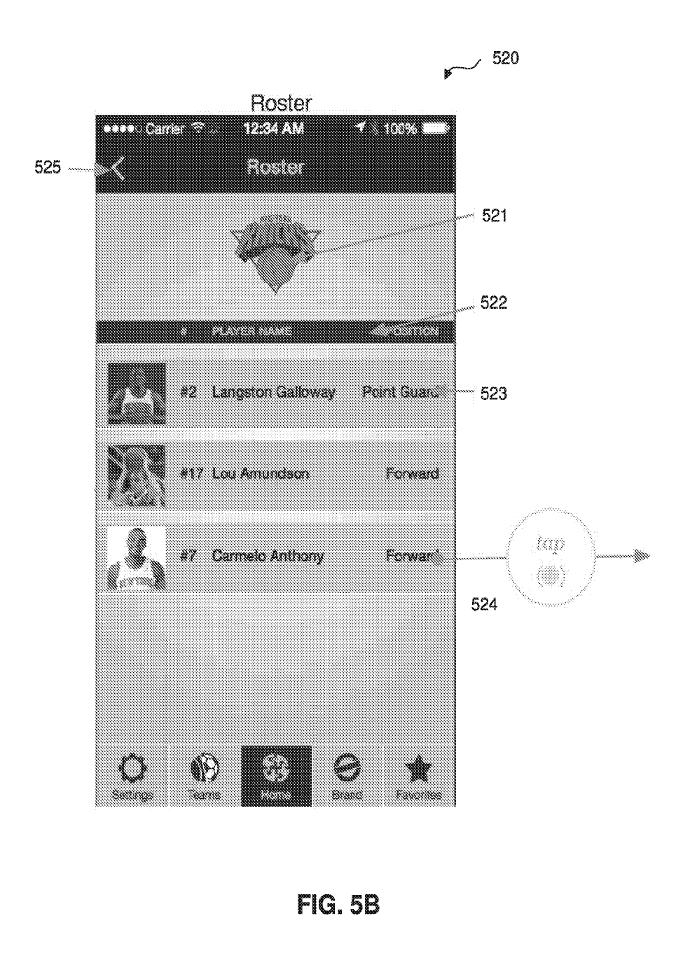

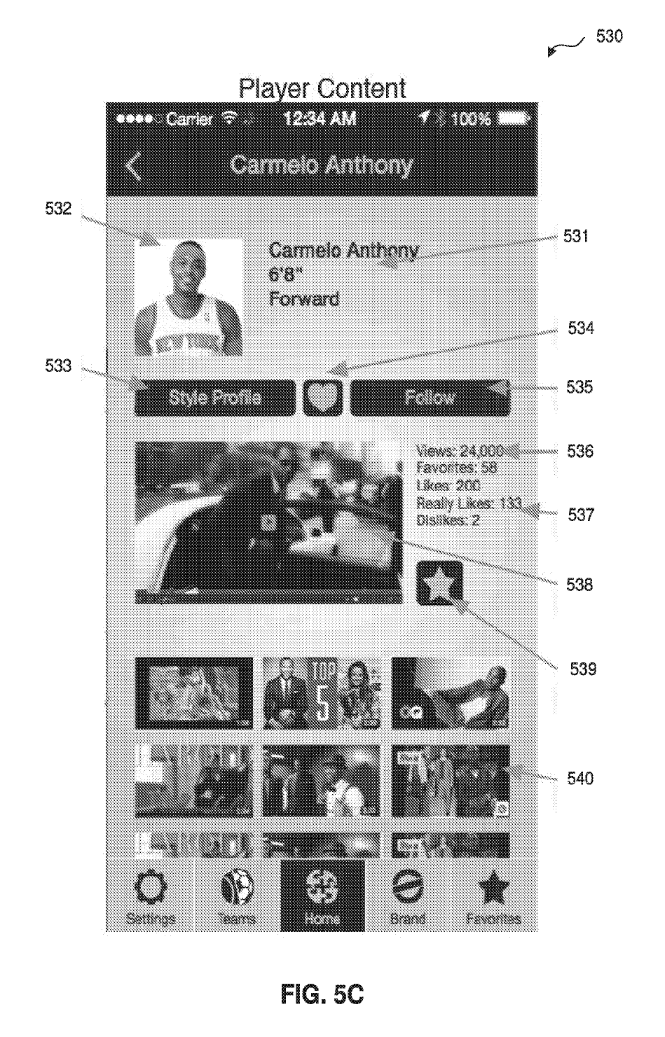

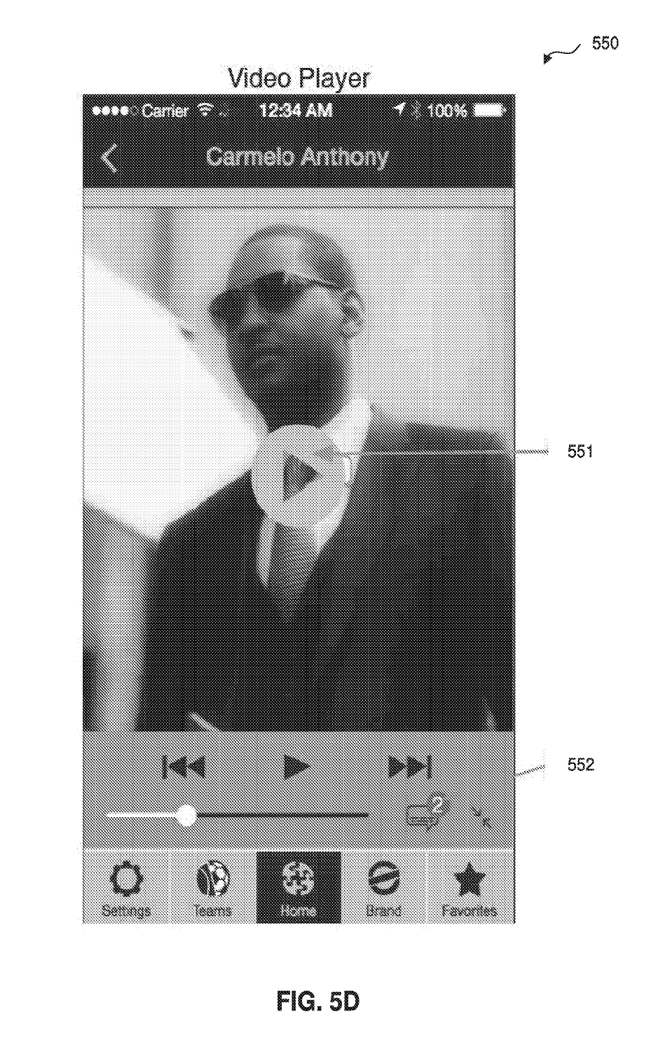

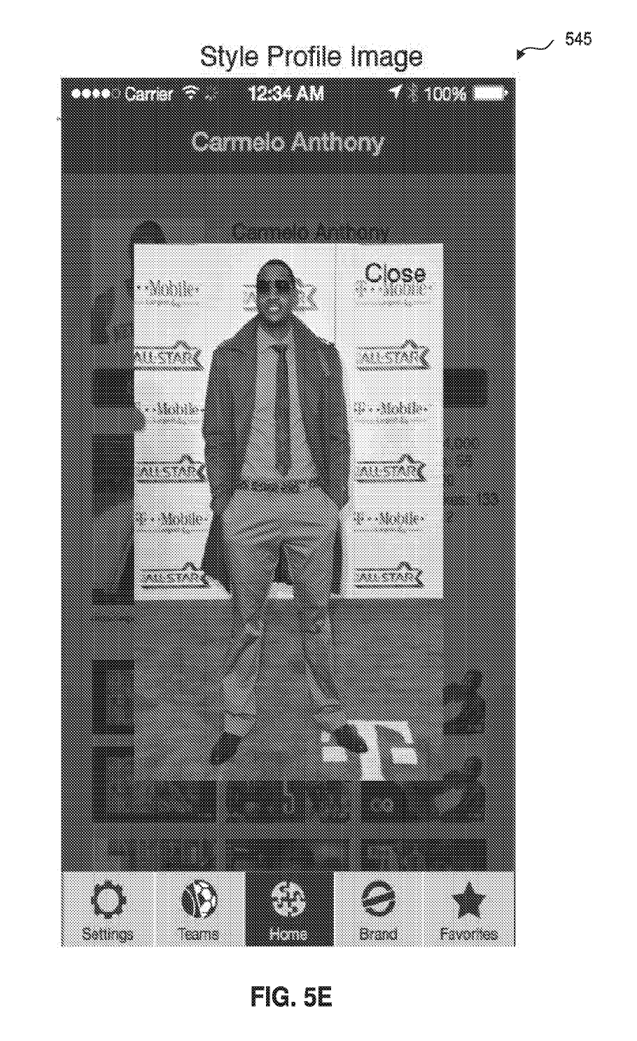

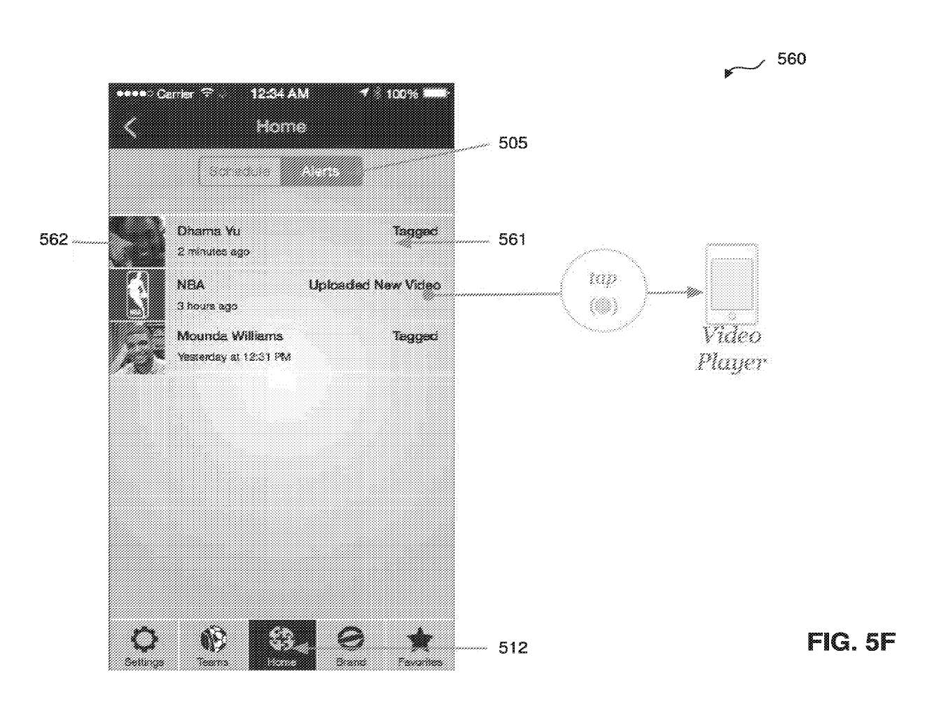

After all required fields are completed; the user can select the “Register” button 442 to submit the registration information. The registration information can be provided to the web service 224 and the web service 224 can be configured to create an account for the user based on the registration information. After the user selects the Register button 442, the flowchart 300 can proceed to the home screen 502 (step 308) as illustrated in FIG. 5A.

At step 308, the home screen 502 is displayed as illustrated in FIG. 5A. The home screen 502 can include a schedule tab 504 and an alerts tab 505. In FIG. 5A, the schedule tab 504 has been selected and schedule information is displayed (step 310). As discussed in more detail below, FIG. 5F illustrates the home screen 502 when the alerts tab 505 is selected (step 312). The schedule information can include the date 506 of the displayed schedule and the teams scheduled to play on the current date 506. Game information 509 can be listed that includes the time of the scheduled games and team identifiers (e.g., team logos and/or names) 509 can be displayed. In an exemplary embodiment, the schedule information displayed on the home screen 502 is based on the location of the user. For example, the schedule information can include one or more teams whose home city is within a distance of the user (e.g., the home city is closest to the location of the user). In an exemplary embodiment, the user will receive a recommendation (e.g., via a notification, pop-up, etc.) to view one or more teams based on the location of the user when the scheduling information is displayed. In this example, by selecting the recommendation, the user navigates to the corresponding team. In an exemplary embodiment, the sensor circuitry 110 is configured to determine the position and/or movement of the electronic device 100 to determine the location of the user.

The home screen 502 can be selected from a navigation menu 515 (306 in FIG. 3) that includes a home screen button 512, settings buttons 510, teams button 511, brand button 513, and favorites button 514. As shown in FIG. 5A, the home screen button 512 has been selected to display the home screen 502. In an exemplary embodiment, the user can select a team (at 507) included in the schedule information to advance the application to the team roster screen 520 as illustrated in FIG. 5B. The team roster screen 520 (step 322) can be accessed from the schedule information screen (step 310) or from the teams button 511 (step 320) of the menu 515.

The team roster screen 520 corresponds to step 322 of FIG. 3, and can include a team identifier (e.g., team logo and/or name) 521 of the selected team, team roster 522 that includes players 523 of the selected team. Each of the players 523 can include a picture, team number, the name of the player, and the position of the player. The players 523 are not limited to this information and can include additional or alternative information in one or more embodiments.

In operation, the user can select a back button 525 to return to the previous screen, or can select a player at 524 to proceed to the player content page 530 (FIG. 5C) associated with the selected player. The user can also select one of the buttons of the navigation menu 515 to navigate to a corresponding section.

Upon selection of the player, the flowchart transitions to the player content page 530 as illustrated in FIG. 5C (step 324). The player content page 530 can include player content information 531 and a player profile picture 532. The player content information 531 can include, for example, the player's name, height, position, and/or other information as would be understood by those skilled in the art. The player content page 530 can also include a Style Profile button 533, a rating button 534, and a Follow button 535. The Style profile button 533 links to a style picture 545 of the player as illustrated in FIG. 5E. The style picture 545 can be a full or partial body style picture of the player.

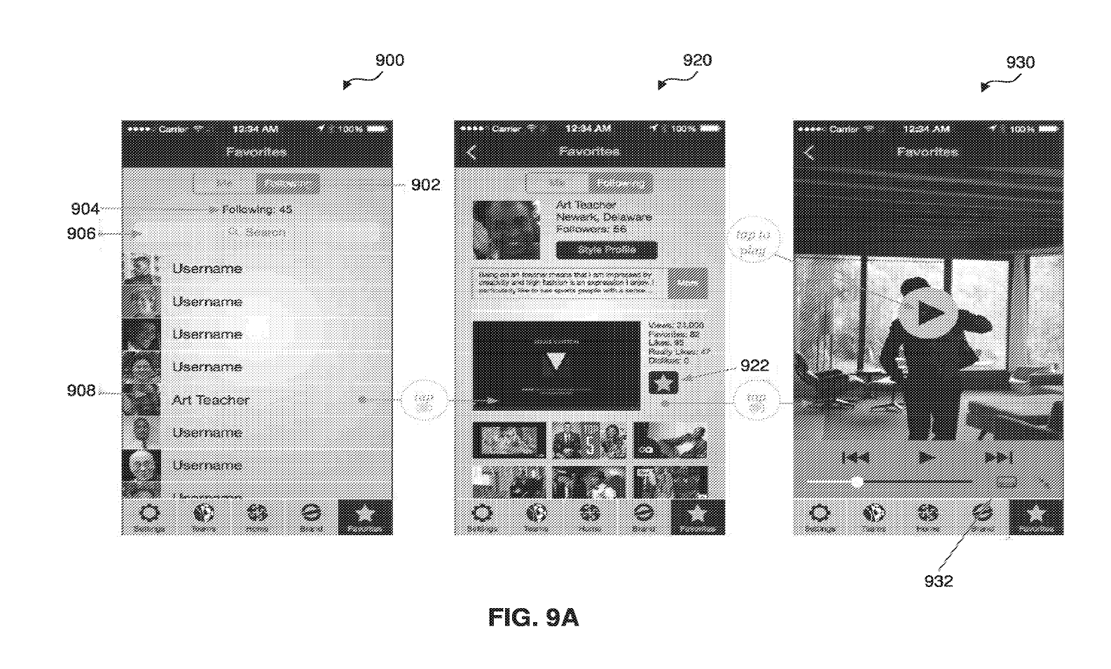

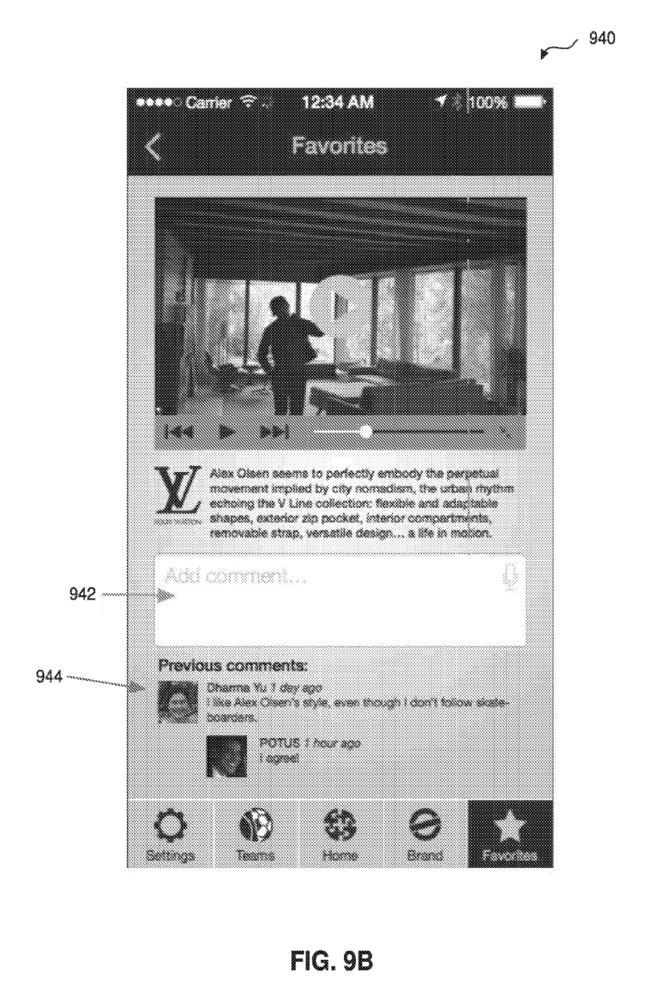

The follow button 535 allows for the user to follow the corresponding player displayed on the player content page 530. If a player is followed, the player's content page is added to the user's favorites list as illustrated in FIG. 9A and discussed in more detail below. In an exemplary embodiment, the player content page 530 will only include the follow button 535 if the player is a registered user of the application 202. In other embodiments, the user can follow other users of the application 202 even if the other users are not athletes and/or celebrities.

The ratings button 534 is configured to allow the user to rate an active video or image 538 being displayed on the player content page 530. The corresponding ratings 537 of the active video or image are displayed on the player content page 530. Additionally, the number of views 536 of the video or image can be indicated.

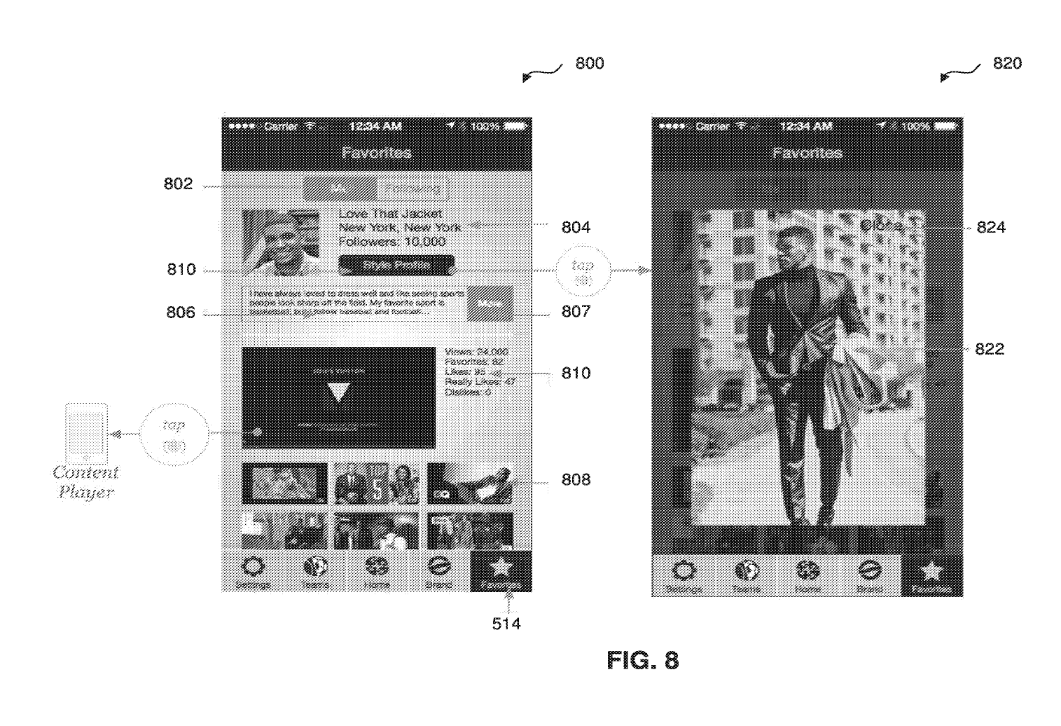

The player content page 530 can also include a favorite's button 539 that is configured to add the active video or image to the user's favorite's page as illustrated in FIG. 8 and discussed in more detail below. The player content page 530 can also include one or more other videos or images 540 that can be selected and viewed by the user. Once selected, the selected video or image becomes the active video 538.

In operation, if the active video 538 is selected by the user, the application 202 can transition to a video player 550 as illustrated in FIG. 5D. In an exemplary embodiment, the active video 538 can be an image, and when selected, a larger view of the image can be displayed similar to the video player 550.

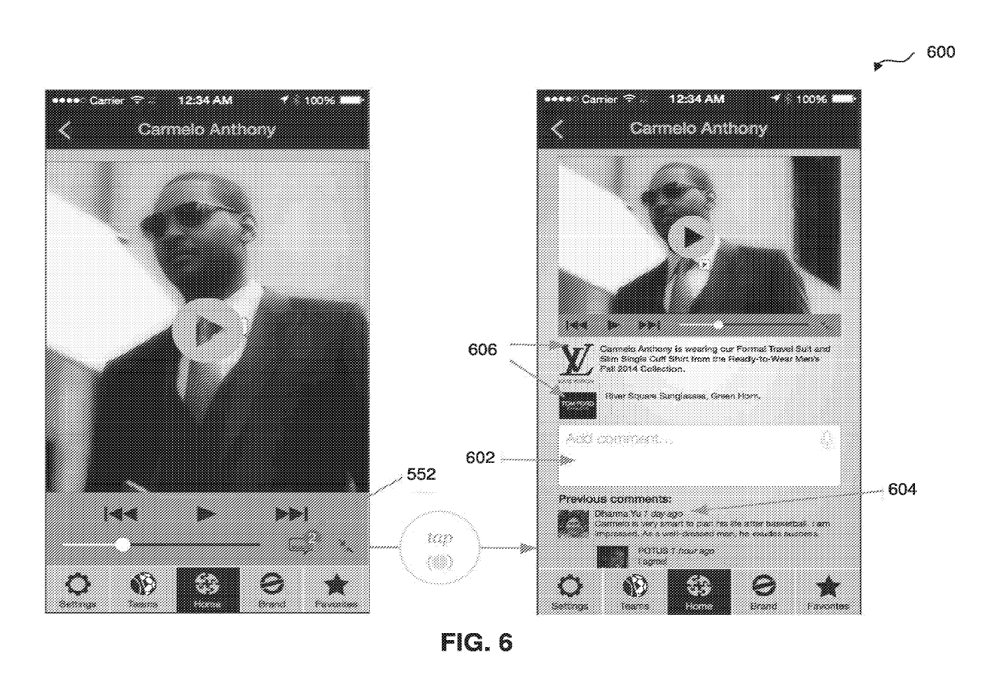

The video player 550 can include a larger or full-screen display 551 of the selected active video 538, and navigation buttons (e.g., play, fast-forward, rewind, pause, stop, etc.) to control the playback of the video. The video player 552 can also include a comments button 552 that navigates the application 202 to a comments section 600 as illustrated in FIG. 6 and discussed in more detail below.

Returning to FIG. 5A, in an exemplary embodiment, the user can select a team (at 507) included in the schedule information to advance the application to the player content pages 530 (FIG. 5C) and/or the video player 550 (FIG. 5D), and display images and/or videos of players of the selected team. In this example, the player content page 530 and/or the video player 550 can be accessed from the schedule information screen (step 310) via the selection of the team 507.

In an exemplary embodiment, the selection of the team can bypass the roster screen 520 and navigate directly to the player content pages 530 (as shown in FIG. 3 by the dashed navigational arrow from 310 to 324) and/or the display of videos and/or images via, for example, the video player 550. In an exemplary embodiment, images and/or videos of players can be displayed (e.g., by the video player 550 (FIG. 5D)) based on one or more player criteria, including, for example, the popularity of the players on the selected team, the players' jersey numbers, positions of the players, player salaries, frequency and/or how recently players have been discussed in other media sources (e.g., television, internet articles and/or multimedia videos, and/or radio discussion) and/or one or more social media sources, and/or one or more other criteria as would be understood by those skilled in the relevant arts. For example, the video player 550 (FIG. 5D) can be configured to display images and/or videos of players based on the popularity of the players such that videos and/or images are displayed for the most popular player on the selected team, followed by videos and/or images of the next most popular player, and so on. In an exemplary embodiment, the images and/or videos of the players are displayed automatically in response to the team being selected. For example, when the team is selected the videos and/or images are played for the players based on one or more player criteria (e.g., popularity of the players).

FIG. 5F illustrates the home screen 502 when the alerts tab 505 is selected (step 312). The alert page 560 of the home screen 502 includes one or more alerts identifying changes (e.g. new activity) to the player content page 530 of a player (or other user) that has been followed by the user. For example, if new material is added, new material has been tagged, and/or new comments have been added to the player content page 530 of a player, an alert 561 will be generated and listed on the alert page 560. The alert 561 can include a profile picture 562 of the corresponding user associated with the alert 561, as well as the timestamp of the alert and/or information identifying the type of alert (e.g., new content added, tagging, etc.). In operation, the user may select an alert, and in response, the application 202 will transition to the content (e.g., video) or player content page 530 identified in the alert 561. For example, the selection the video identified in the second alert 561 will navigate to the video player 550 to play the video.

Returning to FIG. 6, the video player 550 is illustrated with comment button 552. In operation, the selection of the comment button 552 navigates the application 202 to the comments page 600 (step 328). The comments page 600 includes one or more comments 604 associated with the video. The comment page 600 can also include a comment field 602 configured to allow the user to enter a comment for the associated video. The comment page 600 can include one or more tags 606 associated with the video. The tags 606 can include a description of the video, information about the player/user in the video, information about the clothing items, designer and/or brand information, pricing information, store availability information, and/or other information as would be understood by those skilled in the relevant arts.

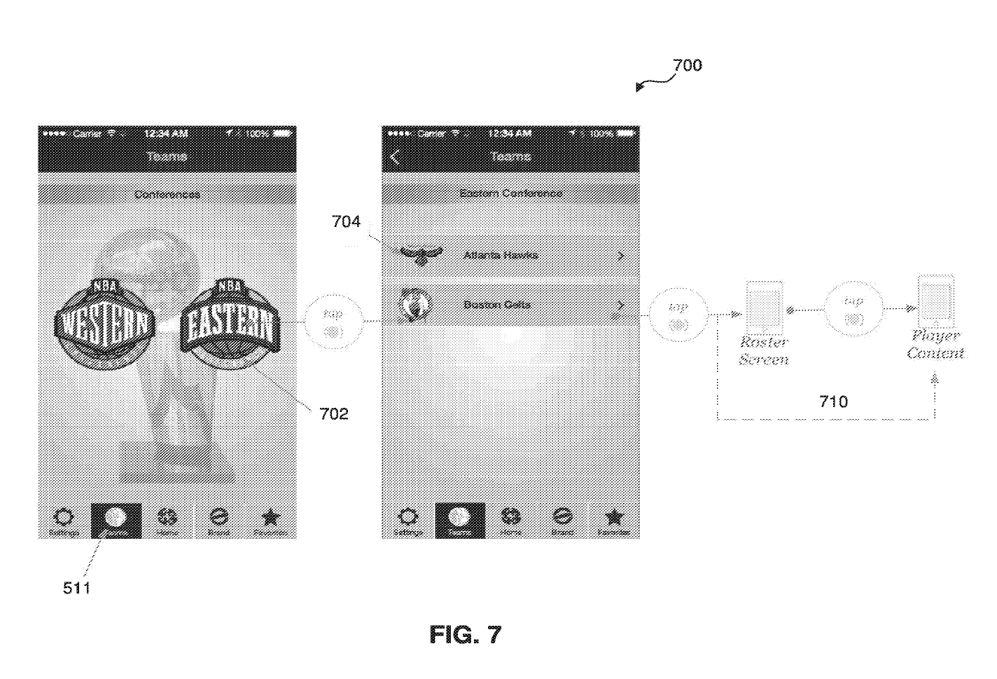

FIG. 7 illustrates teams page 700 (step 320) according to an exemplary embodiment. The teams page 700 can be used to navigate to player content pages 530 of one or more players. The teams page 700 can be accessed via the navigation menu 515 by selecting the teams button 511. The teams page 700 includes subdivisions of the league (e.g., league conferences) 702. Upon selection of one of the league subdivisions 702, the application 202 advances to a next page that includes a listing of the teams 704 included in the league subdivision 702 that was selected. Upon selection of one of the teams 704, the application 202 navigates to the roster screen 520 (step 322) of the selected team 704, where a player can be selected to navigate to the corresponding player content page 530 of the selected player (step 324). In an exemplary embodiment, the teams page 700 can display one or more teams based on the location of the user. For example, the team page 700 can include one or more teams whose home city is within a distance of the user (e.g., one or more teams whose home city is closest to the location of the user). In an exemplary embodiment, the user will receive a recommendation (e.g., via a notification, pop-up, etc.) to view one or more teams based on the location of the user when the teams page 700 is displayed. In this example, by selecting the recommendation, the user navigates to the corresponding team. In an exemplary embodiment, the sensor circuitry 110 is configured to determine the position and/or movement of the electronic device 100 to determine the location of the user.

With continued reference to FIG. 7, in an exemplary embodiment, the teams page 700 can be used to navigate directly to player content pages 530 bypassing the roster screen 520 as shown by navigation sequence 710 in FIG. 7. This sequence is also illustrated in FIG. 3 by the dashed directional arrow from the step 320 to step 324.

In an exemplary embodiment, navigating to the player content pages 530 includes displaying images and/or videos of players of the selected team. As described above, images and/or videos of players on the selected team can be displayed based on one or more player criteria, including, for example, the popularity of the players on the selected team, the players' jersey numbers, positions of the players, player salaries, frequency and/or how recently players have been discussed in other media sources (e.g., television, internet articles and/or multimedia videos, and/or radio discussion) and/or one or more social media sources, and/or one or more other criteria as would be understood by those skilled in the relevant arts. For example, images and/or videos of players can be displayed based on the popularity of the players such that videos and/or images are displayed for the most popular player on the selected team, followed by videos and/or images of the next most popular player, and so on. In an exemplary embodiment, the images and/or videos of the players are displayed automatically in response to the team being selected. For example, when the team is selected the videos and/or images are played for the players based on one or more player criteria (e.g., popularity of the players).

FIG. 8 illustrates the favorite's page 800 according to an exemplary embodiment. The favorite's page 800 can be navigated to by selecting the favorites button 514 of the navigation menu 515.

The favorite's page 800 can include a “me” tab 802 that when selected, includes pictures and images that have been favorited by the user 210 as discussed above with the selection of the favorite's button 539. The favorite's page 800 can include user information 804, user biographical information 806, one or more videos and/or images 808 that have been favorited by the user, where one or more of the favorited videos and/or images 808 can be an active video/image. The biographical information 806 can be expanded by selecting the “more” button 807 to display additional information included in the biographical information 806.

The active video/image can include corresponding statistics that can include, for example, number of views, rankings, etc. When the videos/images 808 have been selected as an active video/image, the favorite's page 800 displays the corresponding statistics of the selected video/image. In operation, when the active video or image is selected, the application 202 can navigate to the player content page 530 of the player/other user associated with the video/image.

The favorite's page 800 can also include a style profile button 810 that links to a style picture 820 of the user. The style picture 820 can be a full or partial body style picture of the user and include clothing and/or accessories 822 that reflect the user's style. The user may select the close button 824 to close the style picture 820 and return the favorite's page 800

In an exemplary embodiment, and with reference to FIG. 9A, the favorite's page 800 can include a following tab 902, that when selected displays the user's favorites (e.g., following) list 900. The favorites list 900 can include the number of players/users that have been followed/favorited 904. The list may be searched using the search field 906. In operation, a player/user 908 on the list 900 can be selected, which navigates the application 202 to the player content page 920 of the selected player/user. The player content page 920 is similar to the player content page 530 discussed above. While accessing the player content page 920, the user may add content on the player content page 920 to their favorites by selecting the favorite's button 922. In this example, the active video/image on the player content page 920 will be added to the user's favorites.

Further, selection of the active video/image will navigate to video player 930, which is similar to video player 550 discussed above. FIG. 9B illustrates a comments section 940 accessible via a comment button 932 on the video player 930. The comments section 940 includes a comment field 942 in which a comment can be entered. The previous comments 944 are found below the comment field 942.

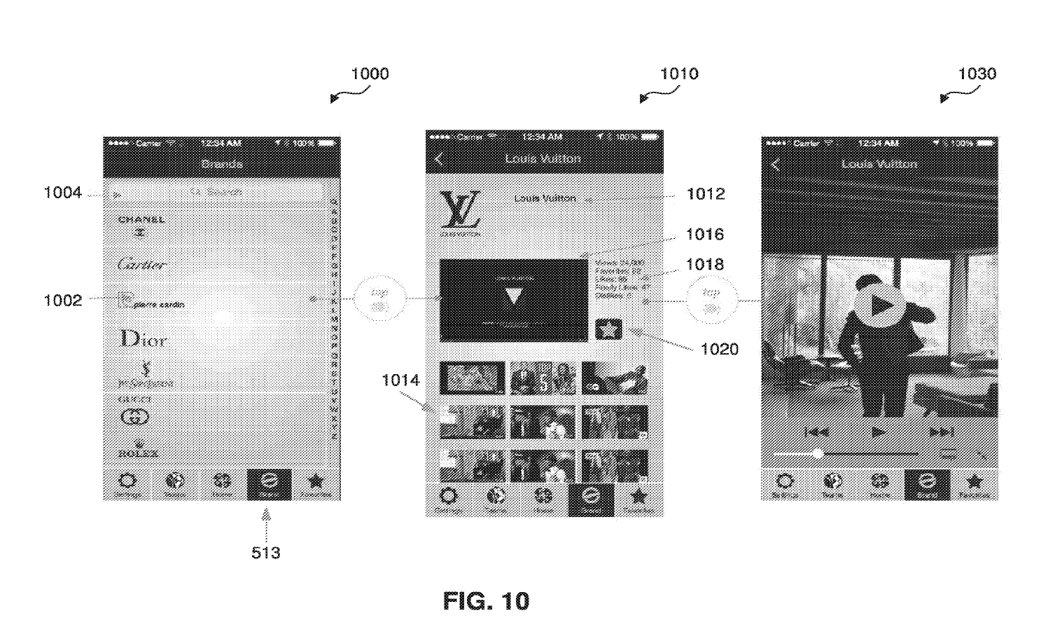

FIG. 10 illustrates a brand page 1000 according to an exemplary embodiment. The brand page 1000 can be accessed by selecting the brand button 513 of the navigation menu 515. The brand page 1000 can include one or more fashion brands 1002. The list of brands 1002 may be searched using the search field 1014. In operation, a user may select a brand from the list of brands 1002, which navigates the application 202 to a corresponding brand content page 1010. The brand content page 1010 can be similar to the player content page 920 of a corresponding player. The brand content page 1010 can include brand information, including the brand logo, name, and/or other identifying information. The brand content page 1010 can include one or more videos and/or images 1014, one of which may be an active video or image 1016. The active video or image 1016 can include corresponding ratings 1018 of the active video or image 1016 that are displayed on the brand content page 1010. This can also include the number of views and/or the number of times the video or image has been favorited by users. While accessing the brand content page 1010, the user may add content on the brand content page 1010 to their favorites by selecting the favorite's button 1020. In this example, the active video/image on the brand content page 1010 will be added to the user's favorites. In operation, the user may select the active video or image, and in response, the application 202 can transition to an image viewer or video player 1030. The image viewer or video player 1030 can be similar to the video player 550.

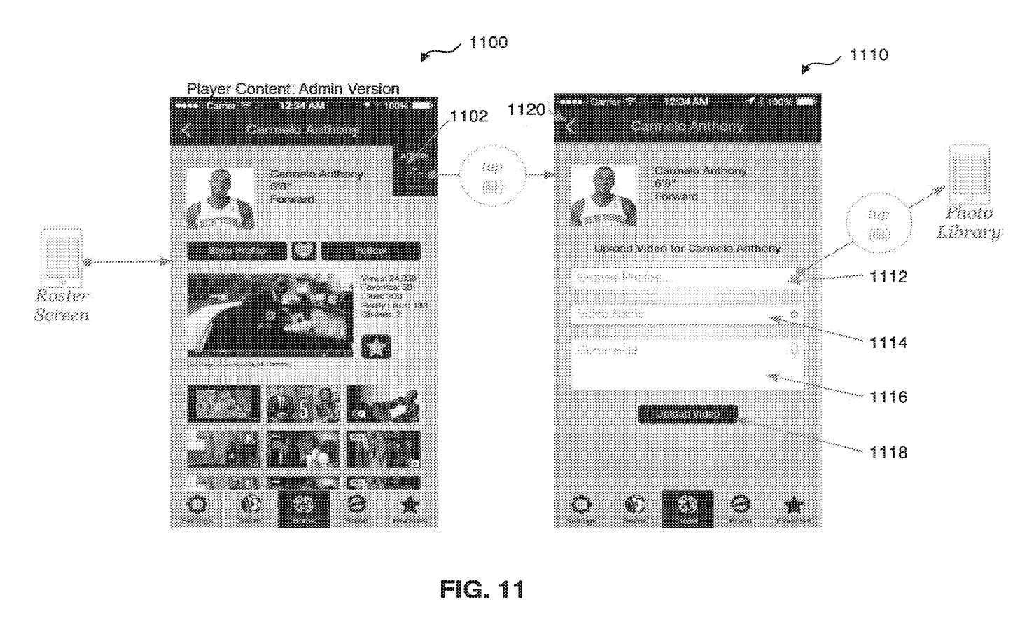

FIG. 11 illustrates a player content page 1100 according to an exemplary embodiment. The player content page 1100 is similar to the player content page 920, but includes an upload button 1102 (step 326 in FIG. 3). The player content page 1100 can be accessed via the team roster screen 520 (step 322) via the teams button 511 of the navigation menu 515.

In operation, selection of the upload button 1102 navigates upload page 1110 that allows for the uploading content (e.g. one or more videos and/or images) to the player content page 1100. The upload page 1110 can include browse field 1112, video name field 1114, comments field 1116, and upload button 1118. The browse field 1112 can be configured allow the user to browse their media library on their electronic device for media content to upload. Once selected, the browse field 1112 can show a path to the file corresponding to the selected media content. The video name field 1114 is configured to accept a name for the corresponding video or image that is being uploaded. The comments field 1116 is configured to accept one or more comments and/or tags that are to be associated with the uploaded content. The upload button 1118 submits the selected content, name and comments for upload to, for example, the media hosting service 212 and/or the database 226. The user may select the back button 1120 to return to the player content page 1100.

In an exemplary embodiment, only the administrator 208 has upload privileges allowing the administrator 208 to upload content via the player content page 1100. That is, general users (e.g., user 210) are not able to upload content via the application 202. However, in another embodiment, one or more general users can be given upload privileges similar to the administrator 208. In this example, the general users can have limited upload privileges or the same privileges as the administrator 208. Further, in some embodiments, the administrator 208 can review and authorize general user uploads before such uploads can be posted to the player content page 1100. In this example, the administrator 208 can receive notifications (e.g., via the notification service 218) notifying of pending uploading from one or more users that are to be reviewed by the administrator 208. If authorized by the administrator 208, the pending content can be posted to the player content page 1100.

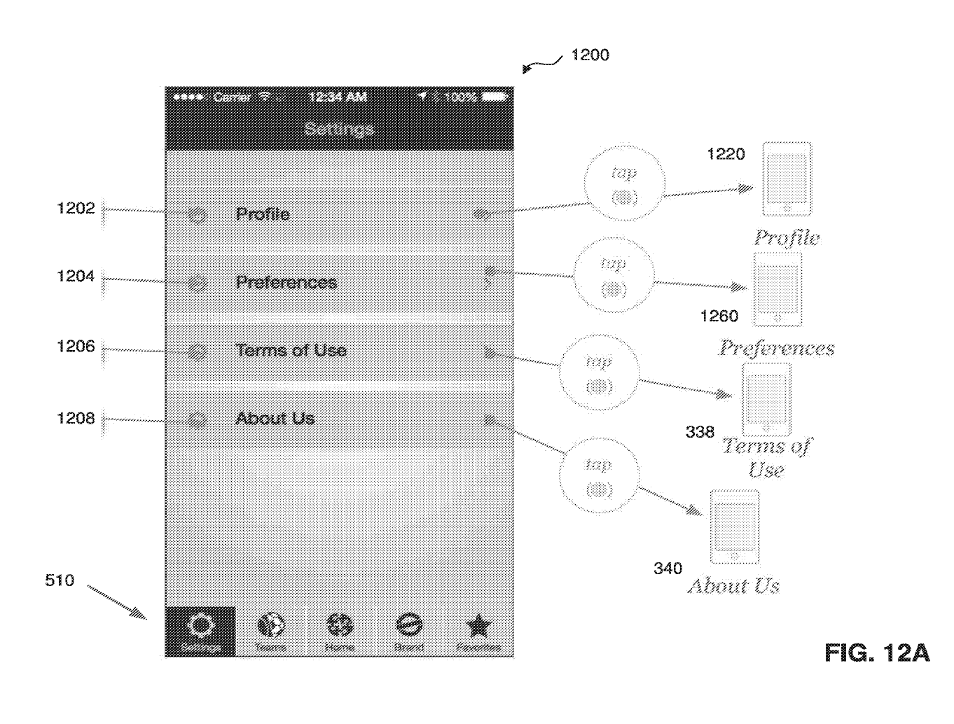

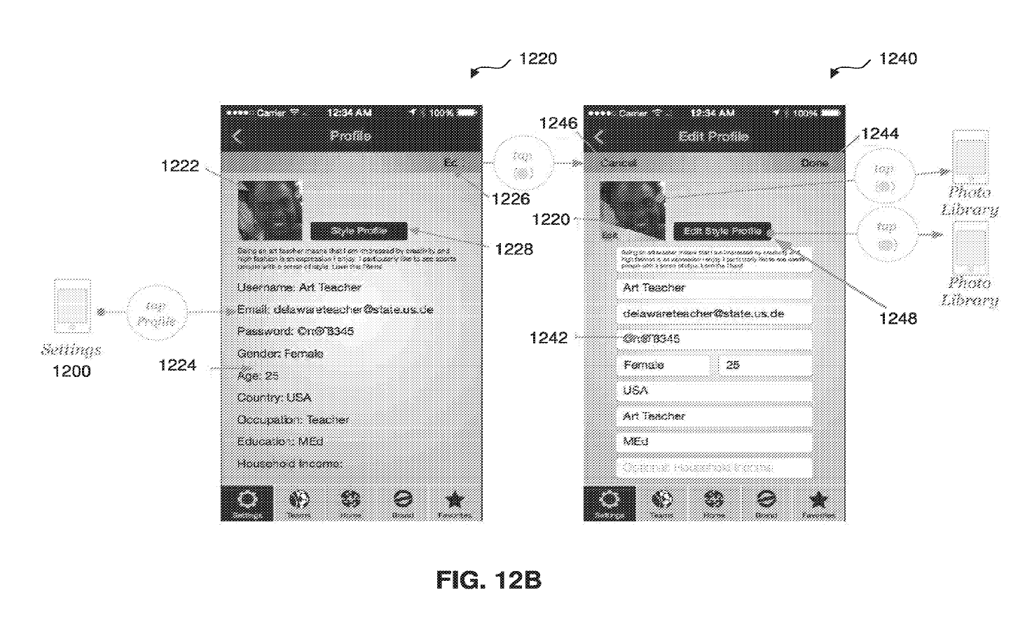

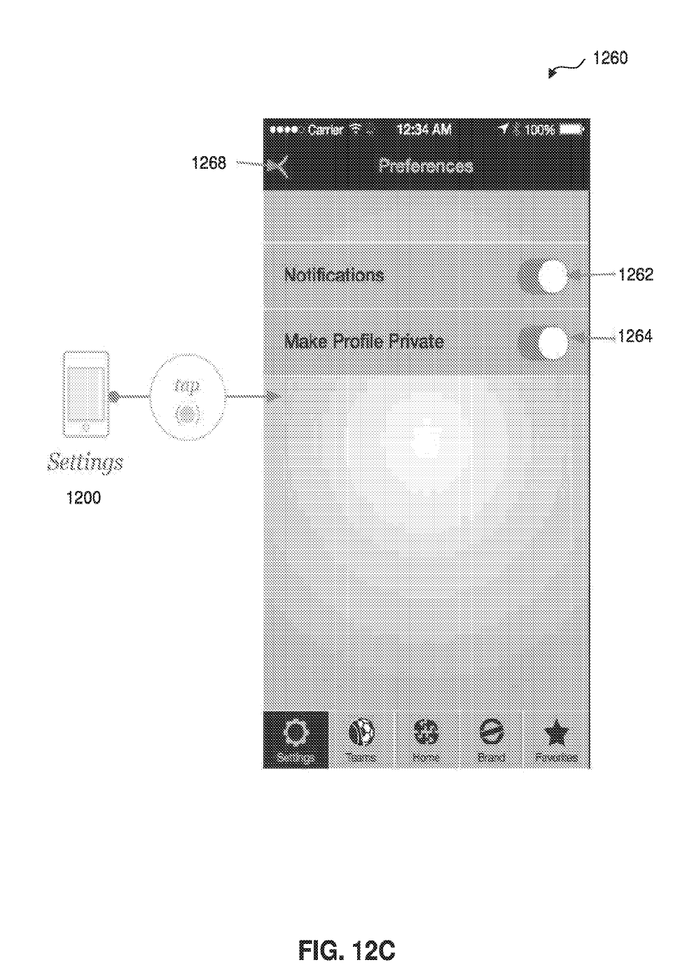

FIG. 12A illustrates a settings page 1200 according to an exemplary embodiment. The settings page 1200 corresponds to step 332 in FIG. 3. The settings page 1200 can be accessed via the settings button 510 of the navigation menu 515.

In an exemplary embodiment, the settings page 1200 can include a profile section 1202, a preferences section 1204, a terms of use section 1206, and an about us section 1208. In operation, the application 202 can navigate to the user's profile page 1220 (step 334) upon selection of the profile section 1202 and can navigate to the preferences page 1260 upon selection of the preferences section 1204. Similarly, the application 202 can navigate to the terms of use page (step 338) upon selection of the terms of use section 1206 and to the about us page (step 340) upon the selection of the about us section 1208.

FIG. 12B illustrates the profile page 1220 according to an exemplary embodiment. The profile page 120 can include a profile picture 1222, profile information 1224, and a style profile button 1228. The profile picture 1222 is a picture uploaded by the user and is associated with the user's account. The profile picture can be, for example, a head-shot of the user. In some embodiments, if a profile picture is not uploaded, the user's account can include a default image or graphic that functions as the user's profile picture. The profile information 1224 can include, for example, the username of the user, the email address of the user, the password associated with the user's account, the user's gender, the age of the user, the user's country, the user's occupation the user's education level, and/or the user's household income. In operation, the style profile button 1228 links to a style picture of the user (e.g., style picture 545). The style picture can be a full or partial body style picture of the user.

In operation, upon selection of edit button 1226, the application 202 navigates to edit profile page 1240 where the user can edit information included in their profile. For example, the user can edit the profile information 1224 by editing the information in the corresponding fields 1242, change their profile picture 1222 by selecting the profile picture 1220 while on the edit profile page 1240, and/or change their style picture by selecting the edit style profile button 1248. In operation, selection of the profile picture 1220 while on the edit profile page 1240 or selection of the edit style profile button 1248 will navigate to the user's media library (e.g., on their electronic device and/or in the cloud) to allow the user to select a new picture or video.

FIG. 12C illustrates the preference page 1260 according to an exemplary embodiment. In an exemplary embodiment, the preference page 1260 can include a notification button 1262 and privacy button 1264. The notification button 1262 is configured to enable and disable notifications. For example, the user can enable or disable push notifications that are generated by the application 202. In an exemplary operation, the user can receive a push notification in response to, for example, a new video having been uploaded. Upon selection of the notification, the application 202 can navigate to the newly uploaded video. The privacy button 1264 is configured to enable and disable privacy of the user's profile. For example, the user can make their profile private by enabling the privacy button 1264. In an exemplary embodiment, user profiles are publicly accessible by default, but are not limited to such a default state. In other embodiments, the user profiles can be private by default. To return to the settings page 1200, the user can select the back button 1268.

In the above exemplary embodiment, the application 202 is described with reference to athletics, with particular reference to professional basketball. However, the application 202 and the associated systems and components can be configured for one or more other sports (e.g., baseball, football, hockey, soccer, etc.) in addition to basketball (or as an alternative to basketball) as would be understood by one of ordinary skill in the relevant arts. Further, the application 202 and the associated systems and components can be configured for non-athletic organizations and/or other demographics as would be understood by one of ordinary skill in the relevant arts.

### Example Computer System Implementation

It will be apparent to persons skilled in the relevant arts that various elements and features of the present disclosure, as described herein, can be implemented in hardware using analog and/or digital circuits, in software, through the execution of instructions by one or more general purpose or special-purpose processors, or as a combination of hardware and software.

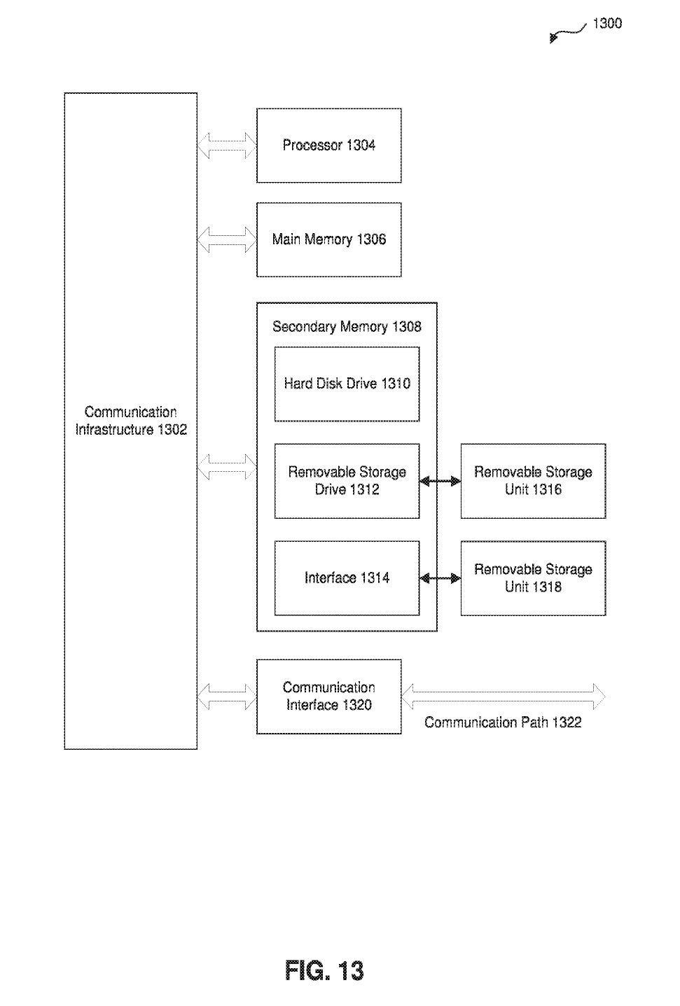

The following description of a computer system is provided for the sake of completeness. Embodiments of the present disclosure can be implemented in hardware, or as a combination of software and hardware. Consequently, embodiments of the disclosure may be implemented in the environment of a computer system, electronic device (e.g., mobile device) or other processing system. An example of such a computer system 1300 is shown in FIG. 13.

The electronic device 100 and/or one or more of the components of the system architecture 200 can be implemented on one or more distinct computer systems 1300.

Computer system 1300 includes processor circuitry that can include one or more processors, such as processor 1304. Processor 1304 can be a special purpose processor that is configured to perform one or more of the operations, processes, methods and/or functions described herein. In an exemplary embodiment, the processor 1304 can be a general purpose processor (e.g., digital signal processor). In an embodiment, the general purpose processor can be configured to perform one or more of the operations, processes, methods and/or functions described herein. For example, the general purpose process can include software that when executed by the processor, controls the processor to perform one or more of the operations, processes, methods and/or functions described herein.

Processor 1304 is connected to a communication infrastructure 1302 (e.g., a bus or network). Various software implementations are described in terms of this exemplary computer system. After reading this description, it will become apparent to a person skilled in the relevant art(s) how to implement the disclosure using other computer systems and/or computer architectures.

Computer system 1300 also includes a main memory 1306 (e.g., random access memory (RAM)), and may also include a secondary memory 1308. Secondary memory 1308 may include, for example, a hard disk drive 1310 and/or a removable storage drive 1312, representing a floppy disk drive, thumb/flash drive, a magnetic tape drive, an optical disk drive, or the like. Removable storage drive 1312 reads from and/or writes to a removable storage unit 1316 in a well-known manner. Removable storage unit 1316 represents a floppy disk, magnetic tape, optical disk, or the like, which is read by and written to by removable storage drive 1312. As will be appreciated by persons skilled in the relevant art(s), removable storage unit 1316 includes a computer usable storage medium having stored therein computer software and/or data.

In alternative implementations, secondary memory 1308 may include other similar devices for allowing computer programs or other instructions to be loaded into computer system 1300. Such devices may include, for example, a removable storage unit 1318 and an interface 1314. Examples of such devices may include a program cartridge and cartridge interface (such as that found in video game devices), a removable memory chip (such as an EPROM, or PROM) and associated socket, a thumb drive and USB port, and other removable storage units 1318 and interfaces 1314 which allow software and/or data to be transferred between removable storage unit 1318 and computer system 1300.

Computer system 1300 may also include a communications interface 1320. Communications interface 1320 allows software and data to be transferred between computer system 1300 and external devices. Examples of communications interface 1320 may include a modem, a network interface (such as an Ethernet card), a communications port, a PCMCIA slot and card, transceiver, etc. Software and data transferred via communications interface 1320 can be in the form of signals which may be electronic, electromagnetic, optical, or other signals capable of being received by communications interface 1320. These signals are provided to communications interface 1320 via a communications path 1322. Communications path 1322 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1316 and 1318 or a hard disk installed in hard disk drive 1310. These computer program products are means for providing software to computer system 1300.

Computer programs (also called computer control logic) are stored in main memory 1306 and/or secondary memory 1308. Computer programs may also be received via communications interface 1320. Such computer programs, when executed, enable the computer system 1300 to implement the present disclosure as discussed herein. In particular, the computer programs, when executed, enable processor 1304 to implement the processes of the present disclosure, such as any of the methods and/or functions described herein. Accordingly, such computer programs represent controllers of the computer system 1300. Where the disclosure is implemented using software, the software may be stored in a computer program product and loaded into computer system 1300 using removable storage drive 1312, interface 1314, or communications interface 1320.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The various aspects of the invention described above can be combined to provide further aspects of the invention. Any and all of the references and products referred to in this application are in their entirety incorporated herein by reference. Aspects of the invention can be modified, if necessary to employ concepts of the references and/or products referred to in this application.

In general, in the following claims, the terms used should not be construed to limit the claims to the specific aspects disclosed in the specification and the claims, but should be construed to include all possible aspects along with the full scope of equivalents to which such claims are entitled. Accordingly, the claims are limited by the disclosure.

1. An electronic device comprising:
communication circuitry configured to communicate with a web service; and control circuity configured to:
receive fashion information associated with one or more athletes from the web service using the communication circuitry, the fashion information including multimedia information and categorical information;
categorize the multimedia information based on categorical information; and
associate at least one portion of the categorized multimedia information with one or more users of the electronic device.

2. The electronic device according to claim 1, wherein the control circuitry is further configured to:
receive commentary of the at least one portion of the categorized multimedia information; and
associate the commentary with the at least one portion of the categorized multimedia information.

3. The electronic device according to claim 1, wherein the multimedia information comprises a video corresponding to the one or more athletes.

4. The electronic device according to claim 1, wherein the fashion information comprises one or more of designer information, brand information, and style information.

5. The electronic device according to claim 1, wherein the associating of the at least one portion of the categorized multimedia information comprising selecting the at least one portion of the categorized multimedia information as favorite multimedia information.

6. The electronic device according to claim 1, wherein the control circuitry is further configured to associate the one or more athletes with the one or more users of the electronic device to receive additional fashion information associated with the one or more athletes.

7. The electronic device according to claim 1, wherein the control circuitry is further configured to add commentary to the multimedia information and to provide the commentary to the web service.

8. The electronic device according to claim 1, wherein the categorical information includes information associated with one or more of athletes, sports leagues and sports teams.

9. The electronic device according to claim 1, wherein the control circuitry is further configured to:
determine a point-of-sale location based on the fashion information; and
purchase a fashion item identified in the fashion information from the determined point-of-sale location.

10. A server comprising:
communication circuitry configured to communicate with an electronic device; and control circuity configured to:
manage fashion information associated with one or more athletes and provide the fashion information to the electronic device using the communication circuitry, the fashion information including multimedia information and categorical information;
categorize the multimedia information based on categorical information; and associate information received from one or more users of the electronic device with the categorized multimedia information.

11. The server according to claim 10, wherein the control circuitry is further configured to:
receive commentary of at least one portion of the categorized multimedia information; and
associate the commentary with the at least one portion of the categorized multimedia information.

12. The server according to claim 10, wherein the multimedia information comprises a video corresponding to the one or more athletes.

13. The server according to claim 10, wherein the fashion information comprises one or more of designer information, brand information, and style information.

14. The server according to claim 10, wherein the associating information received from one or more users comprises associating user-provided commentary to the categorized multimedia information.

15. The server according to claim 10, wherein the associating information received from one or more users comprises identifying at least a portion of the categorized multimedia information as favorite information of the one or more users.

16. The server according to claim 10, wherein the control circuitry is further configured to provide additional fashion information to the one or more users based on the associated information received from one or more users.

17. The server according to claim 1, wherein the categorical information comprises:
information associated with one or more of athletes, sports leagues and sports teams; and
information associated with one or more of designer information, brand information, and style information.

18. The server according to claim 1, wherein the control circuitry is further configured to:
determine a point-of-sale location based on the fashion information;
provide the determined point-of-sale location to the one or more users of the electronic device; and
purchase a fashion item identified in the fashion information from the determined point-of-sale location based on a purchase request received from the one or more users of the electronic device.

19. A method for integrating fashion and athletics using an electronic device, the method comprising:
receiving fashion information associated with one or more athletes from a web service, the fashion information including multimedia information and categorical information;
categorizing the multimedia information based on categorical information;
associating at least one portion of the categorized multimedia information with one or more users of the electronic device; and
receiving additional fashion information from the web service based on the associating the at least one portion of the categorized multimedia information.

20. The method according to claim 19, further comprising:
determining a point-of-sale location based on the fashion information; and
purchasing a fashion item identified in the fashion information from the determined point-of-sale location.

21. A computer program product embodied on a computer-readable medium comprising program instructions, when executed, causes a processor to perform the method of claim 19.

22. An apparatus comprising means to perform the method as claimed in claim 19.
